(19) United States
(12) Patent Application Publication
(10) Pub. No.: US 2025/0124263 A1
(43) Pub. Date: Apr. 17, 2025

(54) GENERATING GUIDANCE DATA FOR AGENTS USING GENERATIVE MACHINE LEARNING MODELS

(71) Applicant: Latent Strategies LLC, Newton, MA (US)

(72) Inventor: John Van Wicheren Reynders, III, Newton, MA (US)

(21) Appl. No.: 18/773,952

(22) Filed: Jul. 16, 2024

Related U.S. Application Data
(60) Provisional application No. 63/591,015, filed on Oct. 17, 2023.

(51) Int. Cl. G06N 3/0475; G06F 18/22; G06F 18/23; G06F 18/28; G06N 3/045; G06N 3/092

(52) U.S. Cl. CPC G06N 3/0475; G06F 18/22; G06F 18/23; G06F 18/28; G06N 3/045; G06N 3/092

(57) ABSTRACT

Methods, systems, and apparatus, including computer programs encoded on a computer storage medium, for generating guidance data to be provided to a target agent interacting with an environment. In one aspect, a method comprises: generating a prompt to be provided to a generative model based at least in part on: (i) one or more target trajectories representing interactions of the target agent with the environment, and (ii) a plurality of reference trajectories representing interactions of each of a plurality of reference agents with the environment, wherein each of the plurality of reference agents differ from the target agent; and generating the guidance data for the target agent using the generative model while the generative model is conditioned on the prompt; and providing the guidance data to the target agent.

### CROSS-REFERENCE TO RELATED APPLICATION

This application claims priority to U.S. Provisional Application No. 63/591,015, filed on Oct. 17, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can generate and provide guidance data to an agent interacting with an environment. In particular, the system can generate and provide guidance data that enables the agent to interact more effectively with the environment.

According to one aspect, there is provided a method that includes: generating a prompt to be provided to a generative model based at least in part on: (i) one or more target trajectories representing interactions of the target agent with the environment, and (ii) a plurality of reference trajectories representing interactions of each of a plurality of reference agents with the environment, wherein each of the plurality of reference agents differ from the target agent; and generating the guidance data for the target agent using the generative model while the generative model is conditioned on the prompt; and providing the guidance data to the target agent.

In some implementations, generating the prompt to be provided to the generative model includes: selecting a base trajectory cluster, from among a set of trajectory clusters, based on the one or more target trajectories representing interactions of the target agent with the environment, wherein each trajectory cluster in the set of trajectory clusters is associated with a respective plurality of reference trajectories; and generating the prompt based at least in part on the base trajectory cluster.

In some implementations, selecting the base trajectory cluster, from among the set of trajectory clusters, based on the one or more target trajectories includes: determining, for each trajectory cluster in the set of trajectory clusters, a respective similarity measure between: (i) the one or more target trajectories, and (ii) the trajectory cluster; and selecting the base trajectory cluster based on the similarity measures.

In some implementations, selecting the base trajectory cluster based on the similarity measures includes selecting the trajectory cluster for the target agent as the trajectory cluster that, among the set of trajectory clusters, is most similar to the one or more target trajectories according to the respective similarity measures for the set of trajectory clusters.

In some implementations, generating the prompt based at least in part on the base trajectory cluster includes: selecting a guidance trajectory cluster from among the set of trajectory clusters; and generating the prompt based at least in part on data characterizing differences between: (i) reference trajectories included in the base trajectory cluster, and (ii) reference trajectories included in the guidance trajectory cluster.

In some implementations, each trajectory cluster in the set of trajectory clusters is associated with a respective performance score based on a respective return associated with each reference trajectory included in the cluster. The return associated with a reference trajectory characterizes a cumulative measure of rewards received during the interaction characterized by the reference trajectory.

In some implementations, for each trajectory cluster, the performance score of the trajectory cluster is based at least in part on a measure of central tendency of the returns associated with the reference trajectories included in the trajectory cluster.

In some implementations, identifying the guidance trajectory cluster from among the set of trajectory clusters includes selecting the guidance trajectory cluster based at least in part on the guidance trajectory cluster having a higher performance score than the base trajectory cluster.

In some implementations, the data characterizing differences between (i) reference trajectories included in the base trajectory cluster, and (ii) reference trajectories included in the guidance trajectory cluster, has been generated by performing operations including: determining, for each feature descriptor in a set of feature descriptors, a difference between: (i) a base value of the feature descriptor based on reference trajectories included in the base trajectory cluster, and (ii) a guidance value of the feature descriptor based on reference trajectories included in the guidance trajectory cluster.

In some implementations, the set of feature descriptors includes a feature descriptor that characterizes a collection of trajectories based on a relative frequency of occurrence of actions in a set of actions among the trajectories in the collection of trajectories.

In some implementations, the set of feature descriptors includes a feature descriptor that characterizes a collection of trajectories based on a number of time steps until a particular action is first performed for trajectories in the collection of trajectories.

In some implementations, the set of feature descriptors includes a feature descriptor that characterizes a collection of trajectories based on a measure of dispersion among actions performed among the trajectories in the collection of trajectories.

In some implementations, the set of feature descriptors includes a feature descriptor that characterizes transition frequencies between respective pairs of actions from a set of actions among the trajectories in the collection of trajectories.

In some implementations, the set of feature descriptors includes a feature descriptor that characterizes lengths of trajectories included in the collection of trajectories.

In some implementations, the set of feature descriptors includes a feature descriptor that characterizes rank or order statistics of actions from a set of actions among the trajectories in the collection of trajectories.

In some implementations, the set of feature descriptors includes a feature descriptor that characterizes a sequence of actions that repeatedly reoccurs among trajectories in the collection of trajectories.

In some implementations, generating the prompt includes, for each of one or more feature descriptors in the set of feature descriptors: generating a sequence of text that characterizes the difference between: (i) the base value of the feature descriptor based on reference trajectories included in the base trajectory cluster, and (ii) the guidance value of the feature descriptor based on reference trajectories included in the guidance trajectory cluster; and including the generated sequence of text in the prompt.

In some implementations, generating the prompt includes: processing a model input that characterizes, for each feature descriptor, the difference between: (i) the base value of the feature descriptor based on reference trajectories included in the base trajectory cluster, and (ii) the guidance value of the feature descriptor based on reference trajectories included in the guidance trajectory cluster, using a language processing model to generate a sequence of text that summarizes the model input; and including the sequence of text generated by the language processing model in the prompt.

In some implementations, generating the prompt based at least in part on data characterizing differences between: (i) reference trajectories included in the base trajectory cluster, and (ii) reference trajectories included in the guidance trajectory cluster includes: accessing precomputed data that, for each pair of trajectory clusters comprising a first trajectory cluster and a second trajectory cluster from the set of trajectory clusters, characterizes differences between: (i) reference trajectories included in the first trajectory cluster, and (ii) reference trajectories included in the second trajectory cluster.

In some implementations, the set of trajectory clusters have been generated by performing operations including: obtaining a collection of reference trajectories generated by a plurality of reference agents; and clustering the collection of reference trajectories to generate a plurality of trajectory clusters.

In some implementations, clustering the collection of reference trajectories to generate the plurality of trajectory clusters includes: clustering the collection of reference trajectories using an expectation-maximization clustering algorithm, or a k-means clustering algorithm, or an agglomerative clustering algorithm, or a Gaussian mixture model clustering algorithm, or a spectral clustering algorithm.

In some implementations, the collection of reference trajectories comprises at least 100,000 reference trajectories.

In some implementations, the plurality of reference agents includes a set of reinforcement learning (RL) agents.

In some implementations, each RL agent in the set of RL agents has generated a plurality of reference trajectories included in a collection of reference trajectories; and each RL agent in the set of RL agents is associated with a respective action selection policy implemented by an action selection neural network that is specific to the RL agent and has been trained by a reinforcement learning training technique.

In some implementations, generating the reference trajectory by an RL agent includes, at each time step in a sequence of time steps: obtaining an observation characterizing a state of the environment at the time step; processing the observation using the action selection neural network of the RL agent to generate an action selection output; and selecting an action to be performed at the time step by the RL agent based on the action selection output.

In some implementations, the set of RL agents includes a plurality of RL agents that each implement respective different exploration strategies.

In some implementations, the set of RL agents includes a plurality of RL agents having action selection neural networks with respective different neural network architectures.

In some implementations, the set of RL agents includes a plurality of RL agents that have each been trained under a different training regimen.

In some implementations, the set of RL agents includes a plurality of RL agents that have each been trained on respective different reward signals.

In some implementations, the set of RL agents includes a plurality of RL agents that have each been trained on different amounts of training data.

In some implementations, the set of RL agents includes a plurality of RL agents that have each been trained to interact with a respective different variant of the environment.

In some implementations, each RL agent in the set of RL agents has been trained using a respective reinforcement learning technique selected from a set of reinforcement learning techniques comprising one or more of: Q learning techniques, actor-critic techniques, and policy gradient techniques.

In some implementations, the method includes assigning the one or more target trajectories representing interactions of the target agent with the environment to respective trajectory clusters in the set of trajectory clusters.

In some implementations, a trajectory representing interaction of an agent with the environment includes, for each of a plurality of time steps, data characterizing an action performed by the agent at the time step. In some implementations, the trajectory further includes, for each of the plurality of time steps, an observation characterizing a state of the environment at the time step.

In some implementations, the action performed by the agent at each time step is selected from a set of actions that includes: (i) one or more atomistic actions, and (ii) one or more optimization actions. Performing an optimization action includes: performing a numerical optimization to identify a sequence of one or more atomistic actions that are predicted to optimize an objective function that measures performance of an agent on a task; and selecting a sequence of atomistic actions as actions to be performed by the agent at a sequence of one or more time steps starting from a current time step.

In some implementations, the generative model is a machine learning model having a set of machine learning model parameters that have been trained using a machine learning training technique.

In some implementations, the generative model is a model that, when conditioned on a prompt, generates samples from a distribution over a space of possible sequences of text.

In some implementations, the generative model includes a neural network.

In some implementations, the generative model has been trained on a corpus of textual data to perform a language modeling task.

In some implementations, training the generative model on the corpus of textual data to perform the language modeling task includes: training the generative model on a corpus of general textual data that is not specific to the environment being interacted with by the target agent; and fine-tuning the generative model on a corpus of environment-specific textual data that is specific to the environment being interacted with by the target agent.

In some implementations, the corpus of environment-specific textual data includes textual data characterizing a collection of reference trajectories.

In some implementations, the corpus of environment-specific textual data includes textual data characterizing a collection of trajectory clusters.

In some implementations, the corpus of environment-specific textual data includes textual data characterizing one or more tasks to be performed by the target agent in the environment.

In some implementations, the request to generate guidance data to be provided to the target agent interacting with the environment includes a request to identify recommended next actions to be performed by the target agent.

In some implementations, the request to generate guidance data to be provided to the target agent interacting with the environment includes a request to recommend a strategy for accomplishing a task in the environment.

In some implementations, the environment is a simulated environment.

In some implementations, the environment is a computer game environment.

In some implementations, the environment is a real-world environment.

In some implementations, the guidance data includes a sequence of text.

In some implementations, providing the guidance data to the agent includes providing the sequence of text for presentation on a display of a user interface.

In some implementations, providing the guidance data to the agent includes: generating audio data that defines a vocalization of the sequence of text; and causing the vocalization of the sequence of text to be played from a speaker.

In some implementations, the method includes: generating video data that depicts an avatar mouthing the sequence of text; and providing the video data for presentation on a display while the vocalization of the sequence of text is played from the speaker.

In some implementations, the guidance data is generated within 1 minute of receiving the request, within 10 seconds of receiving the request, or within 1 second of receiving the request.

According to another aspect, there is provided a system that includes: one or more computers; and one or more storage devices communicatively coupled to the one or more computers, wherein the one or more storage devices store instructions that, when executed by the one or more computers, cause the one or more computers to perform operations of the methods described herein.

According to another aspect, there are provided one or more non-transitory computer storage media storing instructions that when executed by one or more computers cause the one or more computers to perform operations of the methods described herein.

Particular embodiments of the subject matter described in this specification can be implemented so as to realize one or more of the following advantages.

The system described in this specification can provide guidance data to an agent (referred to for convenience as a “target” agent) interacting with an environment, e.g., by performing actions over a sequence of time steps to accomplish one or more tasks in the environment. The guidance data can enable the target agent to interact more effectively with the environment, e.g., by suggesting actions that the target agent can perform next in order to accomplish a task, or by characterizing a higher-level strategy that the agent can adopt to accomplish a task.

The system can generate the guidance data using a generative model conditioned on a prompt that is based on both: (i) one or more target trajectories representing interactions of the target agent with the environment, and (ii) a collection of reference trajectories representing interactions of a set of “reference” agents with the environment. The collection of reference trajectories can include a large number of trajectories that each characterize a respective approach (strategy) for accomplishing tasks in the environment. The prompt can thus include information that enables the generative model to compare and contrast the strategy taken by the target agent to interact with the environment with the strategies represented in the collection of reference trajectories. Thus, when conditioned on the prompt, the generative model can generate specific and informative guidance data that leverages the knowledge and strategies encoded in the collection of reference trajectories.

In order to more comprehensively cover the space of possible strategies for interacting with the environment in the collection of reference trajectories, the system can use a set of reinforcement learning (RL) agents to interact with the environment and generate a large, diverse set of reference trajectories. Each RL agent in the set of RL agents can implement a respective action selection policy, e.g., as a result of implementing a different exploration policy, or having a different neural network architecture, or having been trained using a different training regimen, and so forth. The RL agents can generate large number of trajectories that cover both effective and ineffective strategies for accomplishing tasks in the environment. For instance, certain RL agents can learn through training to generate non-intuitive and highly effective strategies for accomplishing tasks, while other RL agents (e.g., that are implemented with less sophisticated architectures or that are trained on less training data) may generate trajectories representing less effective strategies. Populating the collection of references trajectories with a large number of diverse trajectories can enable the system to generate a more effective prompt for the generative model, e.g., a prompt that includes information that richly characterizes the relationship between the strategy of the target agent and the space of possible strategies for accomplishing a task.

Generating the prompt based on the collection of reference trajectories can be computationally intensive, e.g., because the collection of reference trajectories can include a large number of trajectories. Thus, selecting particular reference trajectories for inclusion in the prompt may require performing large numbers of pairwise comparisons between the target trajectories (of the target agent) and the reference trajectories. As the number of reference trajectories increases, e.g., to more thoroughly cover the space of possible strategies, performing pairwise comparisons between the target trajectories and the reference trajectories may become computationally infeasible and may introduce significant latency into the process of generating guidance data. Further, the length of the prompt is generally limited (e.g., for computational reasons related to the operation of the generative model), and thus directly including the entire collection of reference trajectories in the prompt may be infeasible.

To address these issues, the system can cluster the collection of references trajectories to generate a number of trajectory clusters. The clustering technique can be implemented so as to increase the likelihood that similar trajectories are assigned to the same cluster, and dissimilar trajectories are assigned to different clusters. Clustering the trajectories can reflect the intuition that the collection of references trajectories are not necessarily uniformly distributed across the space of possible trajectories, but rather, naturally group into clusters representing different strategies for solving tasks in the environment. The system can then leverage the trajectory clusters, rather than the raw reference trajectories, in order to generate the prompt for the generative model. The number of trajectory clusters can be less than the number of reference trajectories, e.g., by one or more orders of magnitude, and thus generating the prompt with reference to the trajectory clusters can significantly reduce the computational resources required to generate the prompt. Further, whereas each individual reference trajectory may include “noise” and irrelevant information that is specific to the particular trajectory and does not yield broader insights, a trajectory cluster can define a rich, high-level representation of a strategy for solving a task and can be significantly more informative than any individual reference trajectory.

Moreover, as described above, the generative model operates in a constrained memory space which limits the length of the prompt that is used to condition the generative model. For instance, for a generative model implemented as a self-attention neural network (e.g., having a Transformer architecture), the complexity of the self-attention operations implemented by the generative model can scale quadratically with the length of the prompt. The system described in this specification can operate within the memory constraints of a generative model while still conditioning the generative model on prompts derived from large collections of reference trajectories, e.g., by clustering the reference trajectories and generating prompts based on the resulting trajectory clusters.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram showing an example environment and an agent guidance system that provides guidance data to an agent interacting with the environment.

FIG. 2 is a block diagram an example agent guidance system.

FIG. 3 is a flow diagram of an example process for generating guidance data for an agent.

FIG. 4 is an illustration showing an agent trajectory in comparison with trajectory clusters determined by clustering multiple reference trajectories.

FIG. 5A is an illustration showing the selection of a base trajectory cluster and a guidance trajectory cluster.

FIG. 5B is an illustration of example clusters of reinforcement learning agents trained to perform tasks within an environment.

FIG. 6 is a flow diagram of an example process for generating a prompt for the generative model based on the target agent trajectories and the reference trajectories.

FIG. 7 is a flow diagram of an example process for including data characterizing differences in the values for a particular feature descriptor between a base trajectory cluster and a guidance trajectory cluster within a prompt for generating the guidance data.

FIG. 8 is a flow diagram of an example process for generating a reference agent trajectory.

FIG. 9 is a flow diagram of an example process for clustering reference trajectories.

FIG. 10 is a flow diagram of an example process for training a generative model to produce guidance data for a target agent based on a received prompt.

FIG. 11 is a flow diagram of an example process for generating guidance data based on a prompt.

Like reference numbers and designations in the various drawings indicate like elements.

### DETAILED DESCRIPTION

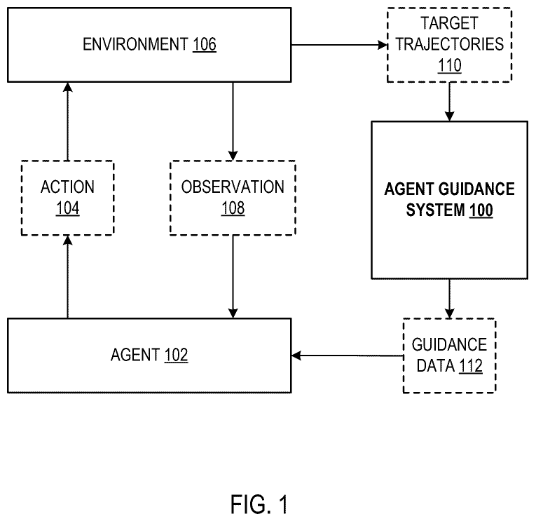

FIG. 1 shows an example agent guidance system 100 that can provide guidance data 112 to an agent 102 interacting with an environment 106. The guidance data 112 can enable the agent 102 to perform a task more effectively within the environment 106. As an example, the guidance data 112 can characterize actions for the target agent to perform in order to accomplish the task. As another example, the guidance data 112 can characterize a higher-level strategy for the agent 102 to accomplish the task.

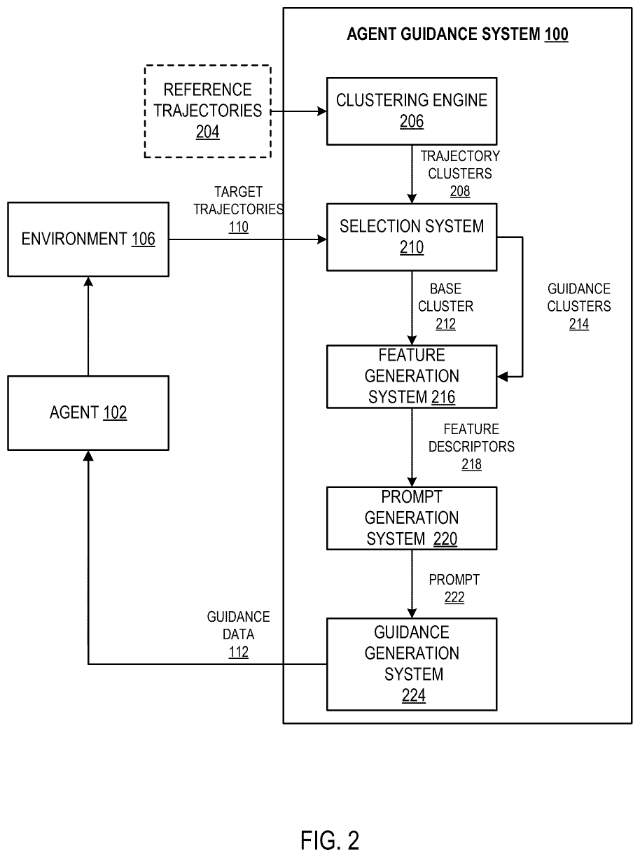

To produce the guidance data 112 for a task, the agent guidance system 100 processes data defining one or more target trajectories 110 that characterize interactions of the agent 102 with the environment 106. In particular, the agent guidance system 100 can generate the guidance data 112 for the agent 102 in response to a request to generate the guidance data based on the one or more target trajectories 110 for the agent 102. The agent guidance system 100 is described in more detail below with reference to FIG. 2.

The agent 102 can perform actions 104 to interact with the environment 106 in order to complete the task in the environment. As the agent 102 performs actions 104 to interact with the environment 106, the agent can receive observations 108 that include data characterizing states of the environment 106 that result from the actions 104 performed by the agent 102. The agent can perform multiple actions 104 while interacting with the environment 106 to complete a task in the environment 106, and, in response to each action, receive a respective observation 108 including data characterizing the resulting state of the environment. Each of the one or more target trajectories 110 can include a respective sequence of actions performed by the agent in the environment, or a respective interleaved sequence of actions and observations of the environment, e.g., an interleaved sequence of the actions 104 and corresponding observations 108.

Generally, the environment 106 can be dynamic in response to the agent 102 performing actions 104 in the environment 106. That is, the agent 102 performing the action 104 in the environment 106 can change the environment 106, e.g., by consuming a resource in the environment 106 or triggering a condition set to change the environment 106.

Throughout this specification, the environment 106 can be any appropriate environment that can be interacted with by an agent that performs actions over a sequence of time steps, e.g., to accomplish tasks in the environment.

Each time step in a sequence of time steps over which an agent interacts with the environment 106 can be associated with a respective reward. The reward for a time step can represent, e.g., whether the agent has accomplished a task at the time step, or a progress of the agent towards accomplishing a task as of the time step. Generally, a reward for a time step can be represented, e.g., by a numerical value, and can be generated by a reward function based on, e.g., the state of the environment 106 at the time step, the action performed by the agent at the time step, or both. As an example, the reward received at a time step can be a binary reward, e.g., having value 1 when a task is accomplished at the time step and 0 otherwise. As another example, the reward for a time step can be drawn from a continuous range, e.g., the reward can be drawn from the range [0,1] and represent a progress of the agent 102 toward accomplishing a task.

An observation for a time step can be any appropriate data characterizing the state of the environment 106 at the time step, and can be represented as an ordered collection of numerical values, e.g., by one or more vectors, matrices, or other tensors of numerical values.

A few examples of agents, actions, and environments are described next, but it will be appreciated that these examples are non-limiting and are provided for illustrative purposes only. Moreover, certain environments described herein can be a real-world environment, i.e., that exists in the real-world, or a simulated environment, i.e., that is implemented by a system of one or more computers. Similarly, certain agents described herein can be real-world agents performing real-world actions or simulated agents performing simulated actions.

In some implementations, the environment 106 can be a computer game environment in a computer game, e.g., a role-playing game, or an open-world sandbox game, or a real-time strategy game, or a turn-based strategy game, or a massively multiplayer online (MMO) game, or a puzzle game, or an educational game, and the agent 102 can represent a player interacting with the game.

The possible actions 104 that can be performed by the agent 102 in the computer game environment include any appropriate actions made available by an interface of the computer game environment. For instance, in a real-time strategy game, the actions 104 that can be performed by the agent 102 can include, e.g., gathering resources, scouting, base management (e.g., constructing buildings, organizing unit production, and so forth), performing research (e.g., to obtain upgrades or new technologies from a technology tree), and so forth.

The observations 108 of the computer game environment 106 can include, e.g., parameters defining the current state of the computer game environment. For instance, observations 108 of the computer game environment 106 can characterize resources and technologies acquired by the agent 102; character health, damage calculations, and the impact of attacks or environmental hazards; the availability and collection of in-game resources (e.g., currency, materials, food, and so forth); the position and orientation of the agent 102; and so forth.

An agent in a computer game environment can perform any appropriate tasks, e.g., completing quests, exploring the environment, defeating enemies, solving puzzles, gathering resources, obtaining new technologies, and so forth.

In a particular example, one or more tasks in the computer game environment 106 can be educational tasks, e.g., such that the computer game is an educational game. For instance, certain tasks in the environment 106 can involve mastering skills or knowledge in areas such as commerce, accounting, business, engineering, mathematics, physics, chemistry, biology, and so forth. In some cases, the educational aspects of the computer game can be obfuscated be represented by in-game elements that indirectly represent corresponding real-world concepts, e.g., the game environment 106 can enable users to unlock technologies in a technology tree to represent the real-world concept of performing research and development to create new technology.

In some implementations, the environment 106 can be a physical environment, and the agent 102 can represent an entity acting in the physical environment, e.g., the agent 102 can represent a robot, a mechanical arm, or an autonomous or semi-autonomous land, sea, or air vehicle.

The possible actions 104 that can be performed by the agent 102 in the physical environment 106 can include, e.g., applying torques to the joints of a robot or a mechanical arm, or providing steering or acceleration control signals to an autonomous or semi-autonomous land, sea, or air vehicle.

The observations 108 of the environment 106 can be generated, e.g., by one or more sensors of the agent, e.g., a camera sensor, a radar sensor, a lidar sensor, an audio sensor, a heat sensor, an accelerometer sensor, a wind speed sensor, etc.

If the agent 102 represents a robot or a mechanical arm, then the agent 102 can perform tasks including, e.g., grasping and moving physical objects in the environment. If the agent 102 represents an autonomous land, sea, or air vehicle, then the agent can perform tasks including, e.g., navigation tasks, e.g., navigating to specified destinations in the environment 106; exploration tasks, e.g., navigating through previously unseen portions of the environment 106; or delivery tasks, e.g., delivering objects to various locations in the environment 106.

As an example, the reward received at each time step can indicate the accomplishment of a task, e.g., a binary reward indicating that a delivery or navigation task is accomplished. As another example, the reward received at each time step can indicate a progress towards the accomplishment of a task, e.g., a continuous reward indicating the proportion of the environment 106 that the agent 102 has explored.

In some implementations, the environment 106 can be an industrial facility, e.g., a data center, a manufacturing facility, or an industrial process plant, e.g., an oil refinery, a paper mill, or a smelting plant. In these implementations, the agent 102 can be a control system of the industrial facility, e.g., that controls at least some of the operations of the industrial facility.

The possible actions 104 that can be performed by the agent 102 controlling the industrial facility can include, e.g., actions to control the rotational speed and direction of fans in a data center, actions to control the movement of robotic arms in a manufacturing facility, or actions to control flow of fluids through pipes or the operation of machines in an industrial process plant.

The observations 108 of the industrial facility can be generated by sensors located in the industrial facility, e.g., heat sensors, pressure sensors, fluid flow sensors, etc.

The agent 102 controlling the industrial facility can perform tasks including, e.g., maintaining temperature within a predefined range (e.g., in a data center), assembling products (e.g., in a manufacturing facility), or generating processed outputs (e.g., in an industrial process plant).

The reward received at each time step can be, e.g., a reward defining a rate of output of the industrial facility, e.g., a number of products being produced per hour in a manufacturing facility, or a volume of processed material being generated per hour in an industrial process plant.

In some implementations, the environment 106 can be a resource allocation environment, where the agent 102 represents an entity (e.g., organization, e.g., business) operating within the resource allocation environment.

Each possible action 104 that can be performed by the agent 102 in the resource allocation environment 106 can represent a resource allocation action, e.g., that defines a respective change to an amount of resources (e.g., funding or personnel) that the entity provides to a respective unit (e.g., department or project within an organization represented by the agent). Other examples of possible actions 104 can include, e.g., modifying supply chains, reconfiguring manufacturing plants, modifying shipping or logistical operations, modifying product pricing (e.g., to implement multi-market price discrimination), modifying product features, or modifying timelines for introducing products into markets.

The observations 108 of the resource allocation environment 106 can characterize, e.g., resources being received by the agent 102 (e.g., revenue to an entity represented by the agent 102), resources being expended by the agent 102 (e.g., expenses of an entity represented by the agent 102), efficiency of the agent 102 (e.g., productivity of personnel working for an entity represented by the agent 102), etc.

The reward received at each time step can be based on one or more of: an operating margin of the organization at the time step, a profit of the organization at the time step, whether the organization has achieved an objective as of the time step (e.g., delivering a product to market), etc.

In some implementations, the environment 106 can be a natural resource environment, e.g., a forestry, farming, fishing, or mining environment, where the agent 102 represents an entity (e.g., an organization) controlling or managing the natural resource environment.

Possible actions 104 that can be performed by the agent 102 in the natural resource environment 106 include, e.g., scheduling planting and harvesting timelines for specified crops in a farming environment, or setting maximum allowable catch-rates in a fishing environment.

The observations 108 of the natural resource environment 106 can characterize, e.g., current levels of various resources in the environment 106 (e.g., current yields of various crops in a farming environment), rates of change in the levels of various resources in the environment 106 (e.g., rates of change in fish populations in a fishing environment), levels of pollutants or ecological damage in the environment 106, or a combination thereof.

The reward received at each time step can be based on yields of natural resources (e.g., crop yields in a farming environment, e.g., measured in tons) extracted from the natural resource environment 106 at the time step.

In some implementations, the environment 106 can be an online educational platform environment, where the agent 102 represents an entity interacting with the online educational platform to master concepts educational domains such as commerce, accounting, business, engineering, mathematics, physics, chemistry, biology, and so forth.

Possible actions 104 that can be performed by the agent 102 in the online educational platform environment 106 include completing tasks such as assignments, readings, quizzes, and so forth.

The observations 108 of the online educational platform environment can include data characterizing actions previously completed by the agent 102 and temporal features such as the time of day and the duration of time that the agent has been active on the online educational platform environment 106.

The reward received at each time step can be based on a performance of the agent 102 on any evaluations (e.g., quizzes) completed by the agent 102 at the time step.

For environments, agents, and tasks such as described above, the guidance data 112 can enable the agent 102 to interact more effectively with the environment 106. For example, the guidance data 112 can suggest actions that the agent 102 can perform next in order to, e.g., accomplish the task, achieve an improved outcome (e.g., receive a greater reward), and so on. As another example, the guidance data 112 can characterize a higher-level strategy that the agent 102 can adopt to, e.g., accomplish the task, achieve an improved outcome (e.g., receive a greater reward), and so on.

The agent 102 can be a user of the agent guidance system 100 and the system 100 can generate the guidance data 112 in response to interactions from the user. For example, the user can request the system 100 to generate the guidance data 112 by interacting with, e.g., an application programming interface (API) of the system 100, a graphical user interface (GUI) of the system 100, and so on. The system 100 can obtain the one or more target trajectories 110 for the user (e.g., the target trajectories 110 can be included as part of the request from the user, can be stored in an external database of agent trajectories and retrieved by the system 100 in response to the request from the user, etc.) and can generate the guidance data 112 for the user based on the obtained target trajectories 110. The system 100 can then present the generated guidance data 112 to the user, e.g., including text characterizing the guidance data 112, an audio vocalization for the guidance data 112, an animation of a digital avatar speaking an audio vocalization for the guidance data 112, and so on.

As a particular example, the agent 102 can be a player interacting with a computer-implemented environment 106 (e.g., a video game, an educational platform, etc.) and can request guidance from the agent guidance system 100 by interacting with a GUI of the environment 106. In response to the request from the player, the system 100 can process the one or more target trajectories 110 for the player to generate the requested guidance data 112 for the player. The system can then provide data to the computer-implemented environment 106 for presenting the generated guidance data 112 to the player within the computer-implemented environment 106. For example, the system 100 can provide data characterizing a text description of the generated guidance data 112 to the computer-implemented environment 106, and the computer-implemented environment 106 can display the text description of the guidance data 112 for the player (e.g., within a text-box within the computer-implemented environment 106). As another example, the system 100 can provide data characterizing an audio vocalization of a description of the generated guidance data 112 to the computer-implemented environment 106, and the computer-implemented environment 106 can play the audio vocalization of the description of the generated guidance data 112 for the player (e.g., as audio within the computer-implemented environment 106). As another example, the system 100 can provide data characterizing an animation of a digital avatar speaking a description of the generated guidance data 112 to the computer-implemented environment 106, and the computer-implemented environment 106 can display the animation of the digital avatar speaking the description of the generated guidance data 112 for the player.

The system 100, when configured according to this specification, can efficiently generate guidance data 112 for the agent 102 in real or near-real time (e.g., 1 second, 10 seconds, 1 minute, etc., after receiving the request, depending on the complexity of the requested guidance data 112) while providing guidance data based on a comparison with a large number of reference trajectories (e.g., more than 100,000 reference trajectories). This enables the system 100 to be used to generate agent guidance data for interactive applications (e.g., for computer-implemented environments 106, such as video games, educational platforms, and so on).

FIG. 2 is a block diagram for an example agent guidance system 100. In general, the agent guidance system 100 processes the one or more target trajectories 110 to generate the guidance data 112 for the agent 102. The agent guidance system 100 includes a clustering engine 206, a selection system 210, a feature generation system 216, a prompt generation system 220, and a guidance generation system 224, which are each described in more detail next.

The clustering engine 206 can process a collection of reference trajectories 204 to produce a plurality of trajectory clusters 208 (e.g., 10, or 100, or 1000 trajectory clusters). Each of the trajectory clusters 208 represents a respective group of the reference trajectories 204 that are similar with one another according to a similarity metric. For example, the clustering engine 206 can use a clustering algorithm to determine the plurality of trajectory clusters 208 by clustering the reference trajectories 204 based on a distance metric measuring distances between the reference trajectories 204.

As a further example, for each of the collection of reference trajectories 204, the system 100 can determine an array of features representing the reference trajectory. The array of features representing a reference trajectory can include numerical values characterizing, e.g., an agent for the reference trajectory, an environment for the reference trajectory, states of the agent for the reference trajectory over a time interval of the reference trajectory, states of the environment for the reference trajectory over the time interval of the reference trajectory, a performance score (e.g., for a particular task) for the reference trajectory, actions performed by the agent during the reference trajectory, a length of the reference trajectory, a received reward for the reference trajectory, and so on. The clustering engine 206 can determine the distance metric between the reference trajectories 204 using differences between the arrays of features for the reference trajectories 204. An example process of clustering the reference trajectories 204 using a clustering algorithm is described in more detail below with reference to FIG. 9.

The system 100 can obtain the collection of reference trajectories 204 in any of a variety of ways. For example, the system can receive (e.g., from a user of the system 100) data specifying part or all of the collection of reference trajectories 204. As a further example, the system 100 can access stored reference trajectories. As another example, the system 100 can monitor one or more reference agents interacting with the environment 106 to generate reference trajectories for the collection of reference trajectories 204. As yet another example, the system 100 can generate reference trajectories for the collection of reference trajectories 204 by controlling one or more reference agents to perform tasks in the environment 106.

The collection of reference trajectories 204 can include reference trajectories from multiple reference agents. The multiple reference agents can each implement different action selection policies for exploring the environment 106 or for performing a task in the environment 106. The collection of reference trajectories 204 can include multiple reference trajectories for each of the multiple reference agents.

Each of the reference agents can be a reinforcement learning (RL) agent configured to interact with the environment 106. Each RL agent can have an associated action selection policy implemented by an action selection neural network that is specific to the RL agent and has been trained by a machine learning training technique, e.g., a reinforcement learning training technique or an imitation learning training technique. For instance, the action selection neural network for each of the RL agents can be trained using any of a variety of reinforcement learning techniques, e.g., Q learning techniques, actor-critic techniques, and policy gradient techniques.

Each RL agent can implement a distinct action selection policy. For example, each RL agent can have an action selection neural network with a distinct different neural network architecture. As another example, each RL agent can have an action selection neural network trained under a distinct training regimen. As another example, each RL agent can have an action selection neural network trained using a distinct reward signal. As another example, each RL agent can have an action selection neural network trained on a distinct amount or type of training data. As yet another example, each RL agent can have an action selection neural network trained to interact with a respective different variant of the environment 106.

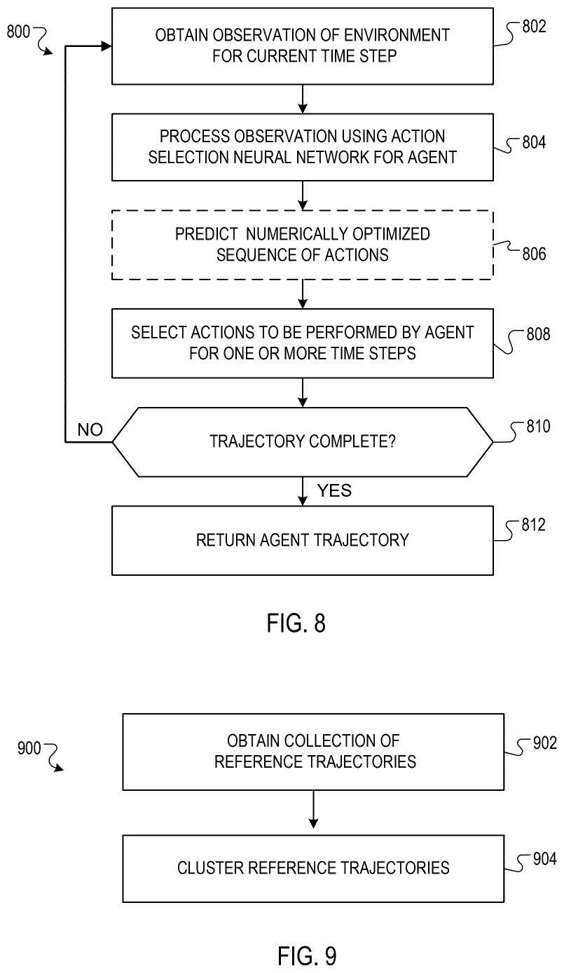

An example process of generating reference trajectories is described in more detail below with reference to FIG. 8. The system 100 can obtain (e.g., pre-compute) the collection of reference trajectories 204 prior to receiving target trajectories and generating guidance data for agents interacting with the environment 106. In turn, the clustering engine 206 can generate (e.g., pre-compute) the trajectory clusters 208 for the collection of reference trajectories 204 prior to receiving target trajectories and generating guidance data for agents interacting with the environment 106. This enables the system 100 to determine (e.g., pre-compute) properties of the trajectory clusters 208, e.g., features of the trajectory clusters 208, descriptions of the trajectory clusters 208, descriptions of differences between the trajectory clusters 208, and so on, before receiving target trajectories and generating guidance data for agents interacting with the environment 106. By using pre-computed properties of the trajectory clusters 208 to generate the guidance data 112, the system can more efficiently generate the guidance data 112 for the agent 102 (e.g., as compared to computing properties of the trajectory clusters 208 each time the system 100 generates guidance data 112).

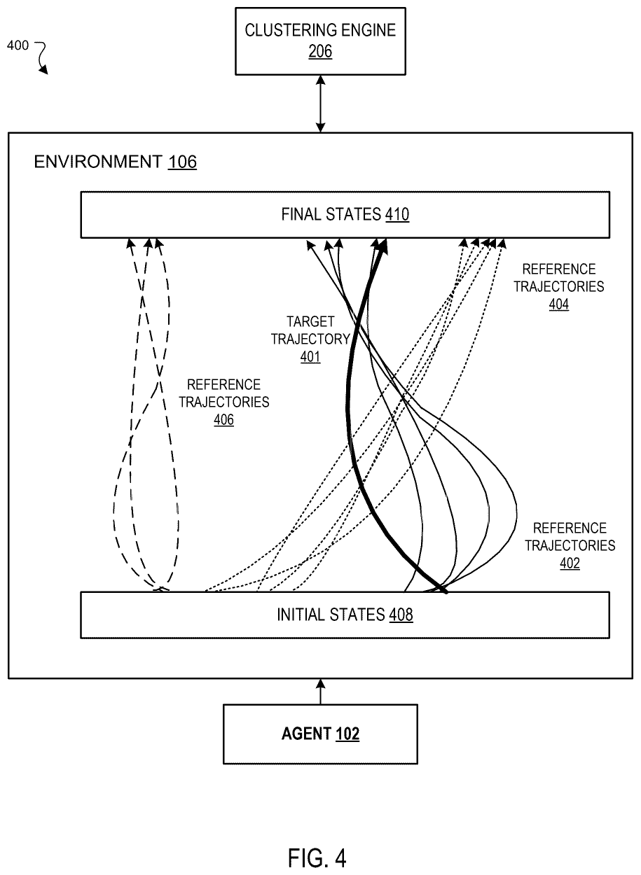

The selection system 210 can process the one or more target trajectories 110 alongside the collection of trajectory clusters 208 to determine a “base” trajectory cluster 212 for the one or more target trajectories 110. In particular, the selection system 210 can determine the base trajectory cluster 212 as the trajectory cluster 208 that is most similar (e.g., according to a similarity measure) with the one or more target trajectories 110. The agent guidance system 100 can use the base trajectory cluster 212 to represent the one or more target trajectories 110 when generating the guidance data 112. In particular, the system 100 can use properties of the selected base trajectory cluster 212 as approximations for the same properties of the one or more target trajectories 110. Selecting a base trajectory cluster 212 to represent the one or more target trajectories is described in more detail below with reference to FIG. 4.

In some implementations, the selection system 210 can process the one or more target trajectories 110 alongside the trajectory clusters 208 to determine one or more “guidance” trajectory clusters 214 for the one or more target trajectories 110. The one or more guidance trajectory clusters 214 can represent reference trajectories from the collection of reference trajectories 204 that are relevant for generating the guidance data 112 for the agent 102.

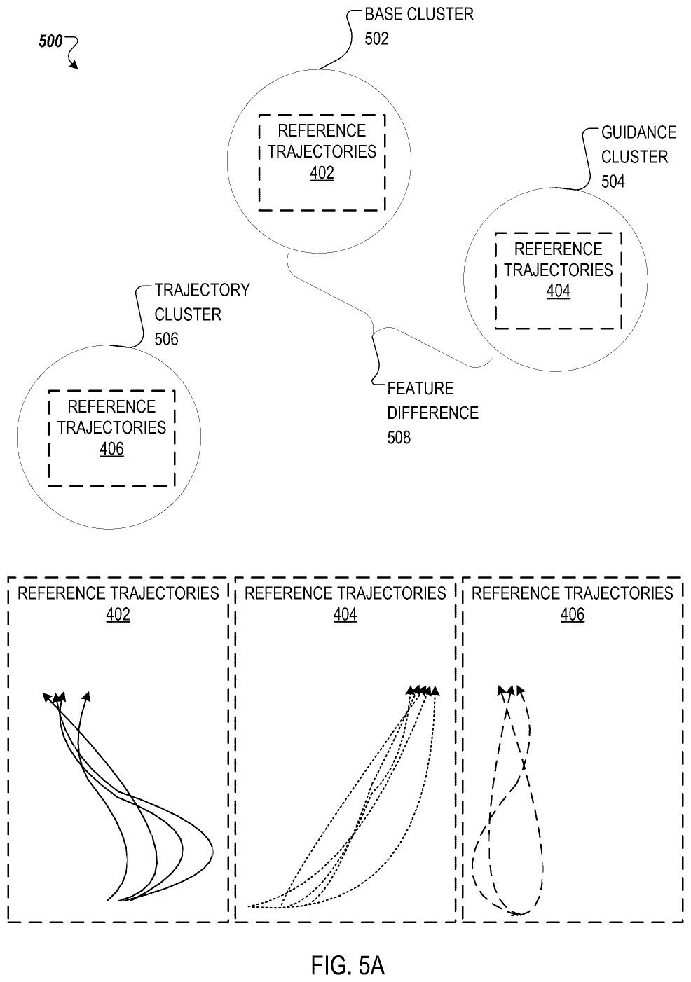

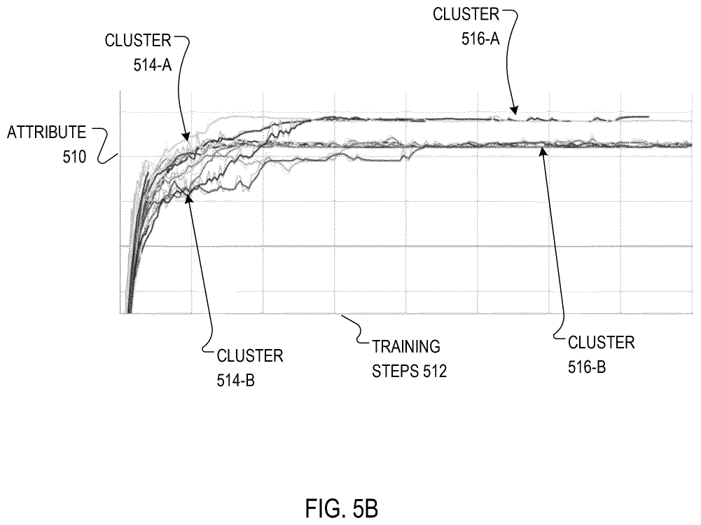

The system agent guidance system 100 can use comparisons between the base trajectory cluster 212 and the one or more guidance trajectory clusters 214 to generate the guidance data 112. In particular, the system 100 can generate guidance data 112 that describes differences between the base trajectory cluster 212 and the selected guidance trajectory clusters 214, e.g., the system can describe how a strategy represented by the base trajectory cluster 212 can be modified to reproduce the strategies represented by the guidance trajectory clusters 214. The selection system 210 can select appropriate guidance trajectory clusters 214 for the purpose of producing the guidance data 112, e.g., by selecting appropriate guidance trajectory clusters 214 for the agent 102 to mimic. The selection of the base trajectory cluster 212 and the guidance trajectory clusters 214 are described in more detail below with reference to FIG. 5A.

The feature generation system 216 can process the selected base trajectory cluster 212 and the one or more guidance trajectory clusters 214 for the one or more target trajectories 110 and produce one or more feature descriptors 218. The feature descriptors 218 can characterize descriptions of trajectories and descriptions of differences between trajectories for the purpose of generating the guidance data 112. In particular, the feature descriptors 218 can characterize differences between particular features of the base trajectory cluster 212 and each of the guidance trajectory clusters 214.

The feature descriptors 218 can characterize aspects of the trajectories represented by the base trajectory cluster 212 and by the one or more guidance trajectory clusters 214. For example, the feature descriptors 218 can characterize rewards for respective agents interacting with the environment 106 (e.g., rewards that characterize how well the respective agents perform tasks within the environment 106) for the base trajectory cluster 212 and by the guidance trajectory clusters 214. As another example, the feature descriptors 218 can characterize states of the environment 106, states of respective agents, and so on, across respective trajectories for interactions between the respective agents with the environment 106 for the base trajectory cluster 212 and by the guidance trajectory clusters 214.

The agent guidance system 100 can therefore use differences between the features of the base trajectory cluster 212 and the features of the one or more guidance trajectory clusters 214 to characterize performance differences for tasks in the environment 106. By determining descriptions of the feature differences between the base trajectory cluster 212 and the one or more guidance trajectory clusters 214, the system 100 can generate descriptions that explain performance differences between respective trajectories represented by the base trajectory cluster 212 and the one or more guidance trajectory clusters 214. For example, if a particular guidance trajectory cluster 214 represents a better performing (e.g., for a particular task in the environment 106) strategy compared to a strategy represented the base trajectory cluster 212, the feature differences between the particular guidance trajectory cluster 214 and the base trajectory cluster 212 can characterize a difference between the respective strategies and the descriptions of the feature differences can provide an explanation of the performance difference between the respective strategies.

As described above, each of the trajectory clusters 208 can be generated (e.g., pre-computed) prior to the agent guidance system 100 generating the guidance data 112 for agents interacting with the environment 106. The system can therefore pre-compute the features, feature differences, and descriptions of the feature differences for the base trajectory cluster 212 and the one or more guidance trajectory clusters 214 before processing the one or more target trajectories 110 to generate the guidance data 112. By pre-computing the features, feature differences, and descriptions of the feature differences for the base trajectory cluster 212 and the one or more guidance trajectory clusters 214, the system can more efficiently generate the guidance data 112 for the agent 102 (e.g., as compared to computing the features, feature differences, and descriptions of feature differences for the one or more target trajectories 110 each time the system 100 generates guidance data 112).

The feature descriptors 218 can characterize features and feature differences between the base trajectory cluster 212 and the one or more guidance trajectory clusters 214 that can be readily translated into text-based descriptions. For example, the feature descriptors 218 can characterize features and feature differences for a proper subset of the array of features used to cluster the reference trajectories 204. The feature descriptors 218 can characterize a proper subset of features and feature differences from the array of features for the reference trajectories 204 that, e.g., are most easily assigned natural language descriptions, yield natural language descriptions that most effectively explain differences between the base trajectory cluster 212 and the guidance trajectory clusters 214, and so on.

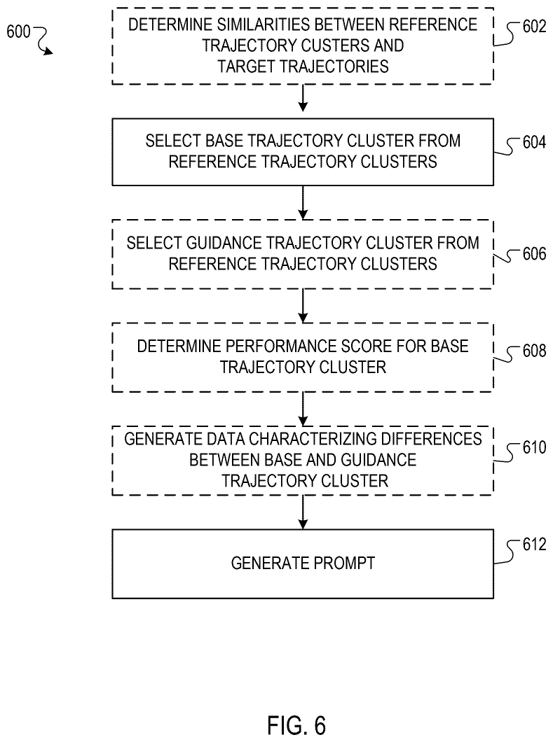

The prompt generation system 220 can process the feature descriptors 218 to generate a prompt 222 for the guidance generation system 224. The guidance generation system 224 can process the prompt 222 to generate the guidance data 112. Example feature descriptors and an example process for generating a prompt by processing feature descriptors using a prompt generation system are described in more detail below with reference to FIG. 6.

The prompt 222 can characterize the one or more target trajectories 110 and relevant reference trajectories for generating the guidance data for the agent 102 (e.g., by including feature descriptors 218 for the base trajectory cluster 212 and guidance trajectory clusters 218).

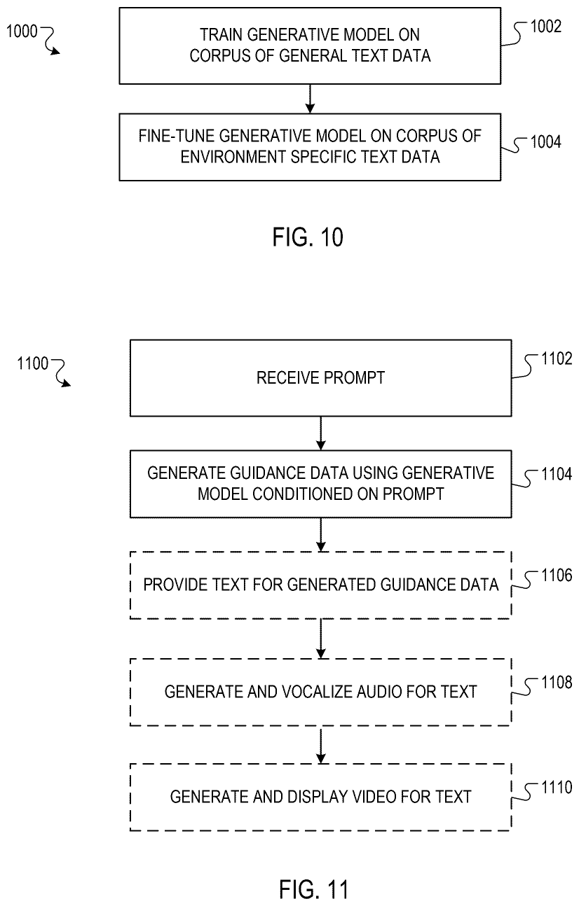

The guidance generation system 224 can include a generative model (e.g., a language model) configured to produce the guidance data 112 based on the prompt 222. An example process of training (e.g., fine-tuning) the generative model to produce the guidance data 112 is described in more detail below with reference to FIG. 10.

The guidance generation system 224 can generate the guidance data 112 in any format appropriate for conveying the guidance information to the agent 102, e.g., text, audio, video, etc. As an example, the guidance generation system can include a text description within the guidance data 112, produce an audio vocalization of the text transcription, and include a video of an avatar speaking the vocalized audio. An example process of generating the guidance data 112 based on the prompt 222 is described in more detail below with reference to FIG. 11.

In some implementations, the system 100 can add the one or more target trajectories 110 to the collection of reference trajectories 204 after processing the one or more target trajectories 110 by assigning the trajectories 110 to one of the trajectory clusters 208. For example, when the system 100 selects the base trajectory cluster 212 to represent the one or more target trajectories 110 (e.g., the base trajectory cluster 212 determined by the system 100 to be a most similar of the trajectory clusters 208 to the one or more target trajectories 110), the system 100 can add the one or more target trajectories 110 to the base trajectory cluster 212.

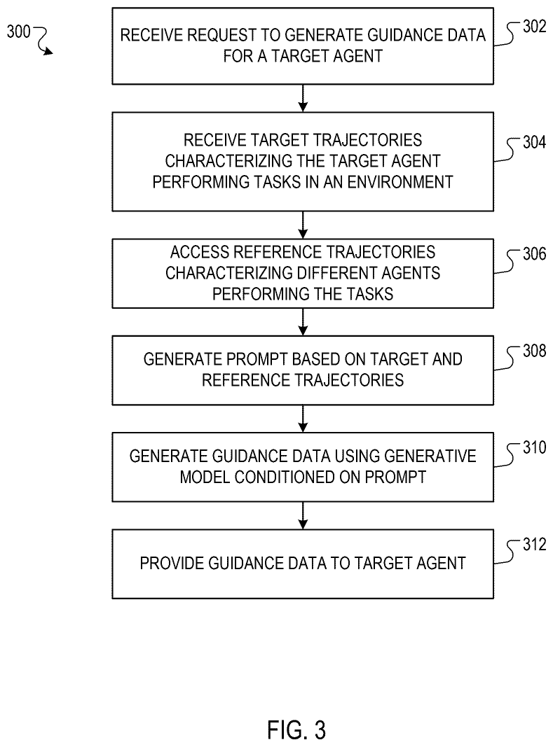

FIG. 3 is a flow diagram of an example process for generating guidance data for an agent. For convenience, the process 300 will be described as being performed by a system of one or more computers located in one or more locations. For example, an agent guidance system, e.g., the agent guidance system 100 of FIG. 1, appropriately programmed in accordance with this specification, can perform the process 300.

The system receives a request to generate guidance data to be provided to a target agent interacting with an environment (step 302). The system can receive any of a variety of types of requests relevant to assisting the agent perform a task within the environment. For example, the request can be that the system identify recommended next actions to be performed by the target agent. As another example, the request can be that the system recommend a strategy for accomplishing a task in the environment.

The system can receive the request to generate the guidance data by means of, e.g., an API of the system, a GUI of the system, and so on. For example, the target agent can be a user of the system and the system can receive the request to generate the guidance data from the user interacting with the system using the API of the system, the GUI of the system, and so on.

The system can receive the request to generate the guidance data as a result of the target agent interacting with the environment. For example, the target can be a player in a computer-implemented environment (e.g., a video game, an educational platform, etc.) and can submit a request to generate the guidance data using a GUI of the computer-implemented environment. The computer-implemented environment can provide the request to generate the guidance data to the system using, e.g., an API of the system.

As an example, the request to generate the guidance data can be generated by a user interacting with a GUI element (e.g., an element of a GUI of the system, an element GUI of a computer-implemented environment, etc.), such as button or menu option to “Get Help”. The request to generate the guidance data can include data characterizing a specific request for help. For example, the request to generate the guidance data can include text submitted by a user that characterizes a request for guidance data for a particular task in the environment (e.g., the request can include text such as “How do I perform task N?”, “How can I do better at task N?”, etc.). As a further example, the user can submit a text explanation of a request for guidance by means of a GUI element (e.g., a text box of a GUI of the system, a GUI of a computer-implemented environment, etc.), and the request to generate guidance data can include the user-submitted text.

The system can receive one or more target trajectories representing interactions of the target agent with the environment (step 304). As an example, the system can receive data characterizing the one or more target trajectories of the target agent from a user of the system. As another example, the system can retrieve data characterizing the one or more target trajectories of the target agent from a database storing the one or more target trajectories. As another example, the system can obtain data characterizing the one or more target trajectories by monitoring the target agent while the target agent interacts with the environment.

For example, when the environment is a computer-implemented environment (e.g., a video game, an educational platform, etc.) and the target agent is a player in the computer-implemented environment, the one or more target trajectories can be obtained by logging or monitoring the target agent's interactions with the computer-implemented environment. As a further example, the computer-implemented environment can log trajectories of interactions with the target agent and can provide the one or more target trajectories to the system (e.g., by sending the one or more target trajectories to the system, by saving the one or more target trajectories in a database accessed by the system, etc.). As another example, the system can obtain the one or more target trajectories by directly monitoring the target agent interacting with the computer-implemented environment.

The system can access a collection of reference trajectories that represent interactions of reference agents with the environment (step 306). In general, the reference agents each differ from the target agent. In some implementations, the collection of reference trajectories includes reference trajectories generated by reference agents trained by the system.

For example, each reference agent can be a reinforcement learning (RL) agent configured to interact with the environment. Each RL agent can have an associated action selection policy implemented by an action selection neural network that is specific to the RL agent and has been trained by a reinforcement learning training technique. The action selection neural network for each of the RL agents can be trained (e.g., by the system) using any of a variety of reinforcement learning techniques, e.g., Q learning techniques, actor-critic techniques, and policy gradient techniques.

Each RL agent can implement a distinct action selection policy. For example, each RL agent can have an action selection neural network with a distinct different neural network architecture. As another example, each RL agent can have an action selection neural network trained under a distinct training regimen. As another example, each RL agent can have an action selection neural network trained using a distinct reward signal. As another example, each RL agent can have an action selection neural network trained on a distinct amount of training data. As yet another example, each RL agent can have an action selection neural network trained to interact with a respective different variant of the environment.

An example process of generating reference trajectories is described in more detail below with reference to FIG. 8.

The system can generate a prompt to be provided to a generative model based at least on the received target trajectories and the accessed reference trajectories (step 308). An example process for generating a prompt for the generative model based on the target agent trajectories and the reference trajectories is described in more detail below with reference to FIG. 6.

The system can generate the guidance data for the target agent using the generative model when the generative model is conditioned on the prompt (310). An example process of generating the guidance data based on the prompt using a generative model is described in more detail below with reference to FIG. 11.

As response to the request, the system can provide the guidance data to the target agent (step 312). The system can generate data for presenting the generated guidance data to the user, e.g., including text characterizing the guidance data, an audio vocalization for the guidance data, an animation of a digital avatar speaking an audio vocalization for the guidance data, and so on. When the environment is a computer-implemented environment (e.g., a video game, an educational platform, etc.), the system can provide the data for presenting the generated guidance data to the user in the computer-implemented environment (e.g., for displaying text characterizing the guidance data, for playing an audio vocalization for the guidance data, for displaying an animation of a digital avatar speaking an audio vocalization for the guidance data, etc., in the computer-implemented environment.

FIG. 4 illustrates an example target trajectory 401 (e.g., one of the one or more target trajectories 110 of FIG. 1) of the agent 102 in comparison with reference trajectories for multiple trajectory clusters as determined by the clustering engine 206.

The target trajectory 401 generally characterizes how the agent 102 interacts the environment 106. The target trajectory 401 begins at one of many possible initial states 408 and ends at one of many possible final states 410. The target trajectory 401 can include a sequence of actions performed by the agent 102 or an interleaved sequence of actions and respective resulting observations.

The reference trajectories similarly characterize how particular reference agents interact with the environment 106. Each of the reference trajectories begins at a respective one of many possible initial states 408 and ends at a respective one of many possible final states 410. Each of the reference trajectories can include a sequence of actions performed by a particular reference agent or an interleaved sequence of actions and respective resulting observations.

For example, an agent can be a mechanical agent, such as a delivery drone, and the task can be delivering packages in a real-world environment. The possible initial states 408 can characterize the agent in the environment 106 with the packages not yet delivered, and the possible final states 410 can characterize the agent in the environment 106 with the packages successfully delivered or not yet delivered (e.g., if the agent is unable to deliver one or more of the packages). A trajectory can characterize a sequence of interleaved actions taken by the agent and resulting observations of the environment between the initial state and the final state for the trajectory (e.g., including the success or failure of each delivery, the order of deliveries, time of deliveries, physical position of the delivery drone at multiple time points, and so on).

In another example, an agent can be a learning agent in a learning environment and the tasks can include, e.g., answering a multiple choice questionnaire related to a learning topic (e.g., mathematics, economics, computer programming, etc.). A trajectory can represent, e.g., a sequence of responses of the learning agent to each question of the questionnaire.

In another example, the tasks for a learning agent can include one or more open-ended problems, e.g., one or more word problems for mathematics, economics, etc.; one or more computer programming tasks; or both.

In another example, the tasks for a learning agent can include interacting with a virtual learning environment using a virtual avatar to complete a set of experiment tasks, e.g., to perform chemistry experiments in a virtual learning environment to create specific compounds, perform certain chemical reactions, identify safe and unsafe laboratory procedures, identify safe and unsafe chemical compounds, or any combination of these.

In another example, the tasks for a learning agent can include interacting with other learning agents in a virtual learning environment. For example, for learning economics, the tasks can include one or more trading tasks. For a trading task, each learning agent can start with predetermined amounts of multiple resources, e.g., money, lumber, steel, stock in a company, etc., and the trading task can be to accumulate predetermined amounts of one or more of the multiple resources.

The clustering engine 206 can process the target trajectory 401 to determine a base trajectory cluster (e.g., the base trajectory cluster 212 of FIG. 2) for the target trajectory. The determined base trajectory cluster for the target trajectory 401 can correspond to one of multiple trajectory clusters determined by the clustering engine 110. The clustering engine 206 can determine the trajectory clusters by applying a clustering operation to multiple reference trajectories, where each trajectory cluster corresponds to a respective set of reference trajectories, as is described below with respect to FIG. 9. The respective sets of reference trajectories (e.g., the reference trajectories 402, 404, and 406) associated with different trajectory clusters are illustrated in FIG. 4 using different types of lines. For example, reference trajectories 402 are illustrated using solid lines, reference trajectories 404 are illustrated using dotted lines, and reference trajectories 408 are illustrated using dashed lines. The target trajectory 401 is shown using a bolded solid line, and can be classified, e.g., by the clustering engine 206, as being most similar to, as an illustrative example, the reference trajectories 402.

Optionally, the system can update the trajectory clusters at one or more time points after receiving additional reference trajectories. For example, as new agents enter the environment 106, the system can receive a respective agent trajectory for each of the new agents interacting with the environment 106. The system can assign each of the new agents to a respective trajectory cluster based on the agent trajectory for the new agent, and include the agent trajectory for the new agent in the assigned trajectory category. After including N additional agent trajectories in the trajectory clusters, the system can again apply the clustering algorithm (e.g., as described in further detail with respect to FIG. 9) to the updated set of reference trajectories to determine an updated set of trajectory clusters. For example, the system can maintain a target number of trajectory clusters by applying the clustering algorithm to cluster the updated set of reference trajectories into the target number of trajectory clusters using clustering criteria based on, e.g., distance metrics among reference trajectories within each cluster, distance metrics between different trajectory clusters, and so on.

As another example, after including additional agent trajectories within the trajectory clusters and in response to determining that one or more of the trajectory clusters satisfy a diversity criterion, the system can split each of clusters satisfying the diversity criterion into two or more new clusters. As another example, after including additional agent trajectories within the trajectory clusters and in response to determining that a plurality of the trajectory clusters satisfy a similarity criterion for the plurality of trajectory clusters, the system can group each of the plurality of trajectory clusters satisfying the similarity criterion into a new cluster.

FIG. 5A illustrates the selection of a base trajectory cluster 502 and a guidance trajectory cluster 504 from a set of trajectory clusters, as performed by an agent guidance system, e.g., the agent guidance system 100.

As described above, the system can generate a set of trajectory clusters by clustering a collection of reference trajectories 204 of reference agents interacting with an environment. The system can associate a particular set of reference trajectories with each generated trajectory cluster. For example, as illustrated in FIG. 5A, the system can generate a set of trajectory clusters that includes the clusters 502, 504, and 506, which have associated reference trajectories 402, 404, and 406, respectively.

When processing the one or more target trajectories 110 from a target agent interacting with the environment, the system can select a base trajectory cluster to represent the one or more target trajectories 110 during later processing. For example, as illustrated in FIG. 5A, the system can select the base trajectory cluster 502 for the one or more target trajectories 110. The base trajectory cluster 502 can correspond to a collection of trajectories of agents interacting with the environment that are similar to the one or more target trajectories 110. For example, the base trajectory cluster 502 can correspond to a collection of trajectories of agents implementing a similar strategy for interacting with the environment as used by the target agent for the one or more target trajectories 110.

In some implementations, the system can determine the base trajectory cluster 502 for the one or more target trajectories 110 by computing similarity measures between the one or more target trajectories 110 and each of the set trajectory clusters. As a particular example, the system can select the individual trajectory cluster most similar to the one or more target trajectories 110 to be the base trajectory cluster 502.

When processing the one or more target trajectories 110, the system can select one or more guidance trajectory clusters for the one or more target trajectories 110. For example, as illustrated in FIG. 5A, the system can select the base trajectory cluster 502 for the one or more target trajectories 110.

The system can select guidance trajectory clusters that can offer useful comparisons to the selected base trajectory cluster for the purposes of generating the guidance data 112. For example, the selected guidance trajectory clusters can represent better performing strategies for the task that the agent 102 may mimic.

The system can apply particular criteria when selecting the guidance trajectory clusters. In some implementations, the system can select guidance trajectory clusters as determined, at least in part, using criteria based on relationships between the selected base trajectory cluster and the guidance trajectory clusters. For example, in some implementations, the system can select guidance trajectory clusters that both (i) improve performance compared to the selected base trajectory cluster and (ii) are similar to the base trajectory cluster, as determined by a similarity measure.

As an illustrative example, the cluster 504 may improve performance over the base trajectory cluster 502, while the cluster 506 may not improve performance over the base trajectory cluster 502. The system may select the guidance trajectory cluster 504, as illustrated in FIG. 5A, based on the cluster 504 improving performance over the base trajectory cluster 502. As another illustrative example, the clusters 504 and 506 may both improve performance over the base trajectory cluster 502, while the cluster 504 may be more similar to the base trajectory cluster 502. The system may select the guidance trajectory cluster 504, as illustrated in FIG. 5A, based on the cluster 504 being the most similar cluster to the base trajectory cluster 502 that improves performance over the base trajectory cluster 502.

The system can associate a set of numerical features to each of the trajectory clusters that characterizes various properties of the cluster. In some implementations, the system may utilize a difference between the associated features to characterize comparisons between the selected base trajectory cluster and guidance trajectory clusters. As illustrated in FIG. 5A, the system can characterize a comparison between the base trajectory cluster 502 and the guidance trajectory cluster 504 using the appropriate feature difference 508.

Example processes of selecting a base trajectory cluster, selecting guidance trajectory clusters, and using feature differences between the base and guidance trajectory clusters as part of generating guidance data are described in more detail below with reference to FIG. 6.

FIG. 5B is an illustration of example clusters of reinforcement learning agents trained to perform a task within an environment.

In particular, FIG. 5B illustrates values of an attribute 510 (e.g., a performance score, an average reward, an average agent state value, an average environment state value, etc.) during training of a plurality of reinforcement learning agents to perform the task in the environment over a sequence of training steps 512. Due to differences in training parameters, training data, network architectures, and so on, the plurality of reinforcement learning agents can learn to implement different strategies to perform the task in the environment.

The plurality of reinforcement learning agents can include clusters of similar agents that implement similar strategies for performing the task in the environment. For example, agents that learn to perform the task more quickly can be clustered together (e.g., as illustrated by cluster 514-A) and agents that learn to perform the task more slowly can be clustered together (e.g., as illustrated by cluster 514-B). As another example, agents that learn strategies resulting in similar values for the attribute 510 can also be clustered together (e.g., as illustrated by cluster 516-A and cluster 516-B). Trajectories generated by similar (e.g., clustered) agents can be clustered together as reference trajectory clusters.

FIG. 6 is a flow diagram of an example process for generating a prompt for use in generating guidance data for a target agent performing a task in an environment based on target agent trajectories and reference trajectories. For convenience, the process 600 will be described as being performed by a system of one or more computers located in one or more locations. For example, an agent guidance system, e.g., the agent guidance system 100 of FIG. 1, appropriately programmed in accordance with this specification, can perform the process 600.

In some implementations, the system can determine similarities between the target agent trajectories and each of a set of reference trajectory clusters (step 602). For example, the system can determine similarities between the target trajectories and each of the set of reference trajectory clusters by determining a similarity of actions performed within the target trajectories and within reference trajectories represented by the reference trajectory clusters. As a further example, the system can determine a similarity between the target trajectories and the reference trajectory clusters based on a relative frequency of occurrence of actions from a particular set of actions. As another example, the system can determine a similarity between the target trajectories and the reference trajectory clusters based on a number of time steps until a particular action is first performed. As another example, the system can determine a similarity between the target trajectories and the reference trajectory clusters based on a measure of dispersion (e.g., a standard deviation, a variance, an entropy, etc.) among actions performed within the trajectories. As another example, the system can determine a similarity between the target trajectories and the reference trajectory clusters based on transition frequencies between respective pairs of actions from a set of actions (e.g., for each pair of a first action and a second action from the set of actions, the transition frequency for the first action and the second action can be a likelihood that the second action if performed after the first action is performed). As another example, the system can determine a similarity between the target trajectories and the reference trajectory clusters based on trajectory lengths (e.g., a number of time steps to reach a particular state of the environment, to perform a particular task in the environment, etc.). As another example, the system can determine a similarity between the target trajectories and the reference trajectory clusters based on rank or order statistics for actions from a set of actions (e.g., an identity of a most performed action, a frequency of a most performed action, etc.). As another example, the system can determine a similarity between the target trajectories and the reference trajectory clusters based on sequences of actions that repeatedly reoccurs (e.g., is performed at least a threshold number of times) among the trajectories. As another example, the system can determine a similarity between the target trajectories and the reference trajectory clusters based on sequences of states (e.g., agent states, environment states, etc.) attained by the trajectories.

The system can select a base trajectory cluster from the set of reference trajectory clusters to represent the target agent trajectories (step 604). For example, the system can, for each trajectory cluster in the set of reference trajectory clusters, compute a respective similarity measure between the target trajectories and the reference trajectory cluster. The system can determine base trajectory the reference trajectory cluster most similar to the target trajectories based on the similarity measures computed for each reference trajectory cluster.

In some implementations, the system can determine a performance score for the base trajectory cluster (step 606). The performance score for the base trajectory cluster can characterize a performance of trajectories represented by the base trajectory cluster for a task in the environment. For example, the base trajectory cluster can represent a plurality of trajectories that implement a particular strategy for performing the task in the environment and the performance score for the base trajectory cluster can characterize how effectively the particular strategy performs the task in the environment.

As an example, the system can associate a respective performance score with each of the reference trajectory clusters based on a respective return associated with each reference trajectory included within the cluster. The performance score for a reference trajectory cluster can characterize a performance of the agent trajectories included within the reference trajectory cluster. The return associated with a particular reference trajectory can characterize a cumulative measure of rewards received during the interaction characterized by the reference trajectory. In some implementations, the system can determine the performance score for each reference trajectory cluster based at least in part on a measure of central tendency of the returns associated with the reference trajectories included in the cluster. For example, the system can determine the performance score for each reference trajectory cluster as an average of the returns associated with the reference trajectories included in the cluster.

In some implementations, the system can select a guidance trajectory cluster from the set of reference trajectory clusters (step 608). The system can select a guidance trajectory cluster that represents reference trajectories that attain better performance on the task compared to the target trajectories. For example, the system can select the guidance trajectory cluster based, at least in part, on the guidance trajectory cluster having a higher performance score for the task than the base trajectory cluster. The system can further select a guidance trajectory cluster that represents reference agent interactions with the environment that are similar to the target agent trajectories. In particular, the system can select a reference trajectory cluster most similar to the base trajectory cluster that attains a higher performance score than the base trajectory cluster to be the guidance trajectory cluster.

The system can select the guidance trajectory clusters based on a similarity metric between the reference trajectory clusters and the base trajectory cluster. In particular, the similarity metric between the reference trajectory clusters and the base trajectory cluster can measure a similarity between the trajectories represented by the reference trajectory clusters and the trajectories represented by the base trajectory cluster. For example, the system can determine a similarity of actions performed within trajectories represented by the base trajectory cluster and within trajectories represented by the reference trajectory clusters, as described above with reference to step 602.

In some implementations, the system can select a plurality of guidance trajectory clusters from the set of reference trajectory clusters.

In some implementations, the system can generate data that characterizes differences between the reference trajectories included in the base trajectory cluster and the reference trajectories included in the guidance trajectory cluster (step 610). For example, the system can assign values to each feature descriptor in a set of feature descriptors for each reference trajectory cluster. The system can characterize differences between the reference trajectories within the base and the guidance trajectory cluster based on a difference between the values of the feature descriptors for the base trajectory cluster and the values of the feature descriptors for the guidance trajectory cluster.

In some implementations, the set of feature descriptors includes a feature descriptor that can characterize a collection of trajectories based on a relative frequency of occurrence of actions in a set of actions among the trajectories in the collection.

In some implementations, the set of feature descriptors includes a feature descriptor that can characterize a collection of trajectories based on a number of time steps until a particular action is first performed for trajectories in the collection.

In some implementations, the set of feature descriptors includes a feature descriptor that can characterize a collection of trajectories based on a measure of dispersion (e.g., a standard deviation, a variance, an entropy, etc.) among actions performed among the trajectories in the collection.

In some implementations, the set of feature descriptors includes a feature descriptor that can characterize transition frequencies between respective pairs of actions from a set of actions among the trajectories in the collection. For example, for each pair of a first action and a second action from the set of actions, the transition frequency for the first action and the second action can be a likelihood that the second action if performed after the first action is performed.

In some implementations, the set of feature descriptors includes a feature descriptor that can characterize lengths of trajectories (e.g., a number of time steps to reach a particular state of the environment, to perform a particular task in the environment, etc.) included in the collection.

In some implementations, the set of feature descriptors includes a feature descriptor that can characterize rank or order statistics of actions from a set of actions (e.g., an identity of a most performed action, a frequency of a most performed action, etc.) among the trajectories in the collection.

In some implementations, the set of feature descriptors includes a feature descriptor that can characterize a sequence of actions that repeatedly reoccurs (e.g., is performed at least a threshold number of times) among the trajectories in the collection.

In some implementations, the set of feature descriptors includes a feature descriptor that can characterize sequences of states (e.g., agent states, environment states, etc.) among the trajectories in the collection. For example, the set of feature descriptors can include a feature descriptor that characterizes differences between states attained by trajectories in the collection that begin from a same initial state (e.g., a same initial agent state, a same initial environment state, etc.).

In general, the feature descriptors can characterize features and feature differences that can be readily translated into text-based descriptions. For example, the feature descriptors can characterize features and feature differences that, e.g., are most easily assigned natural language descriptions, yield natural language descriptions that most effectively explain differences between the reference trajectories included in the base trajectory cluster and the reference trajectories included in the guidance trajectory cluster, and so on, such as the features and feature differences described above with respect to step 602.

The system can generate a prompt for the guidance data based on, at least, characteristics of the selected base trajectory cluster (612). In some implementations, the prompt can include data characterizing one or more trajectories represented by the base trajectory cluster (e.g., the one or more target trajectories from the target agent). When the system selects a guidance trajectory cluster, the prompt can include data characterizing one or more reference trajectories represented by the guidance trajectory cluster.

In some implementations, the system can generate the prompt using the characterized differences between the selected base trajectory cluster and guidance trajectory cluster. As an example, the system can generate the prompt based on characteristics of the base trajectory cluster and data characterizing, for each feature descriptor, differences in the feature descriptor between the base trajectory cluster and the guidance trajectory cluster.

In particular, the system can include within the prompt a natural language description of the differences in each feature descriptor between the base trajectory cluster and the guidance trajectory cluster. For example, the system can include within the prompt a pre-defined natural language template for each feature descriptor describing a difference in the feature descriptor between the base trajectory cluster and the guidance trajectory cluster. For a feature descriptor F having a value V_{F} in the base trajectory cluster, which differs by Δ_{F} from the value in the guidance trajectory cluster, the pre-defined natural language template can, for example, be “In relation to F, the strategy implemented by the target agent resulted in V_{F}, which differs by Δ_{F} from a potentially more effective strategy”. By generating a natural language description of feature descriptor differences between the base trajectory cluster and the guidance trajectory cluster, the system can efficiently generate concise and human-interpretable prompts to generate guidance data for the target agent.

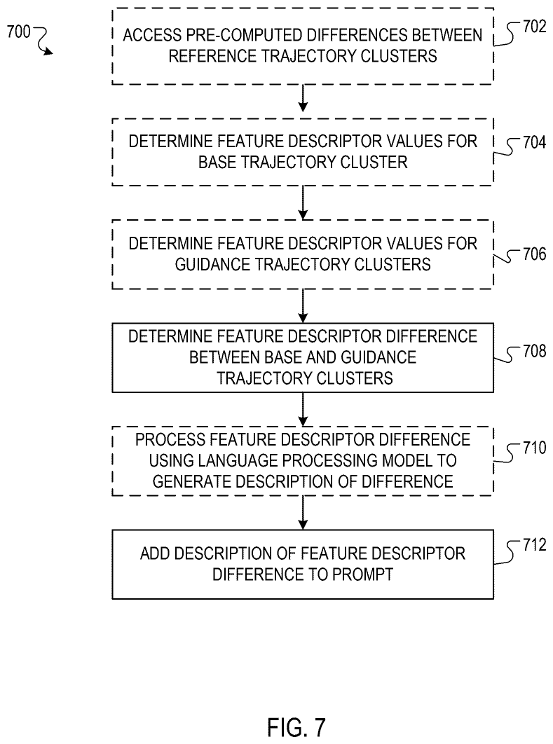

An example process of determining data characterizing differences between the base trajectory cluster and the guidance trajectory cluster for a particular feature descriptor to include within the prompt is described in more detail below with reference to FIG. 7.

In some implementations, the system can identify differences between the selected base trajectory cluster and the target agent trajectories. As an example, the system can generate the prompt based on characteristics of the base trajectory cluster and data characterizing, for each feature descriptor, differences in the feature descriptor between the base trajectory cluster and the target agent trajectories. As a further example, the system can include within the prompt a natural language description of the differences in each feature descriptor between the base trajectory cluster and the target agent trajectories. By generating a natural language description of feature descriptor differences between the base trajectory cluster and the target trajectories, the system can efficiently generate prompts to generate guidance data for the target agent specific to the target agent trajectories.

FIG. 7 is a flow diagram of an example process for including data characterizing differences in the values for a particular feature descriptor between a base trajectory cluster and a guidance trajectory cluster within a prompt that is processed by a generative model to generate guidance data. For convenience, the process 700 will be described as being performed by a system of one or more computers located in one or more locations. For example, an agent guidance system, e.g., the agent guidance system 100 of FIG. 1, appropriately programmed in accordance with this specification, can perform the process 700.

In some implementations, the system can access precomputed data characterizing the particular feature descriptor value for each of the reference trajectory clusters (step 702). For example, the system can access precomputed feature descriptor value differences between the base and guidance trajectory clusters. As another example, the system can access pre-determined text sequences that characterize the differences between the values of each feature descriptor for the base and guidance trajectory clusters.

In some implementations, the system can determine the value of the particular feature descriptor for the base trajectory cluster (step 704). For example, the system can compute the value of the particular feature descriptor for the base trajectory cluster by processing the reference trajectories associated with the base trajectory cluster. As another example, when the system accesses precomputed data characterizing values of the particular feature descriptor, the system can retrieve the value of the particular feature descriptor for the base trajectory cluster from the precomputed data.

In some implementations, the system can determine the value of the particular feature descriptor for the guidance trajectory cluster (step 706). For example, the system can compute the value of the particular feature descriptor for the guidance trajectory cluster by processing the reference trajectories associated with the guidance trajectory cluster. As another example, when the system accesses precomputed data characterizing values of the particular feature descriptor, the system can retrieve the value of the particular feature descriptor for the guidance trajectory cluster from the precomputed data.

The system can determine a difference between values of the particular feature descriptor for the base trajectory cluster and the guidance trajectory cluster (step 708). For example, when the system determines the values of the particular feature descriptor for the base and guidance trajectory cluster, the system can compute the difference between the values of the particular feature descriptor for the base and guidance trajectory cluster. As another example, when the system accesses precomputed data characterizing values of the particular feature descriptor, the system can retrieve a precomputed difference between the values of the particular feature descriptor for the base and guidance trajectory cluster.

In some implementations, the system can process the difference in the particular feature descriptor value using a language model to generate a text sequence characterizing the difference (step 710). The language model can have any of a variety of architectures suited for generating text based on differences in feature descriptor values. For example, the language model can be a large language model that includes neural networks employing attention mechanisms. As a particular example, the language model can be a Transformer neural network. The language model can be pre-trained to perform a language processing task using a general text corpus and can be fine-tuned to produce guidance data based on received prompts, e.g., by fine-tuning the language model using training data that includes feature descriptors generated by the system. An example process for training the language model to produce guidance data for a target agent based on a received prompt is described in more detail below with reference to FIG. 10.

The system can add a description characterizing the difference between the particular feature descriptor for the base and the guidance trajectory clusters to the prompt (step 712). For example, the description can include data identifying the particular feature descriptor and characterizing the difference of the particular feature vector. As another example, when the system generates sequences of text characterizing the differences between the values of each feature descriptor for the base and guidance trajectory clusters, description can include the generated sequences of text as part in the generated prompt.

As described above with reference to FIG. 6, the system can include within the prompt a pre-defined natural language template describing the difference between the particular feature descriptor between the base trajectory cluster and the guidance trajectory cluster. For example, denoting the particular feature descriptor by F, with value V_{F} in the base trajectory cluster which differs by Δ_{F} from the value in the guidance trajectory cluster, the pre-defined natural language template for the particular feature descriptor can be “In relation to F, the strategy implemented by the target agent resulted in V_{F}, which differs by Δ_{F} from a potentially more effective strategy”.

FIG. 8 is a flow diagram of an example process for generating a reference agent trajectory of a reference agent interacting with an environment. For convenience, the process 800 will be described as being performed by a system of one or more computers located in one or more locations. For example, an agent guidance system, e.g., the agent guidance system 100 of FIG. 1, appropriately programmed in accordance with this specification, can perform the process 800.

At each time step, the system can obtain an observation that characterizes the state of the environment at the time step (step 802). For example, the system can receive the observation from one or more sensors monitoring the environment while the reference agent interacts with the environment.

The system can process the observation of the current state of the environment using an action selection neural network for the reference agent to produce an action selection network output for the time step (step 804). The action selection neural network can have any appropriate architecture for processing observations of the environment to generate respective action selection network outputs. For example, the action selection neural network can include, e.g., multi-layer perceptron layers, convolutional layers, attention layers, recurrent layers, and so on. The action selection neural network can be trained to process observations of the environment to generate respective action selection network outputs using any appropriate machine learning technique using any appropriate training data.

In some implementations, the system can generate a set of one or more optimization actions (step 806). Each of the optimization actions can be a particular sequence of one or more atomistic actions to be performed by the agent over one or more future time steps that are predicted to optimize an objective function, associated with the optimization action, that measures performance of the agent on a task. The system can identify each of the optimization actions by performing a numerical optimization of the objective function associated with the optimization action.

The system can select actions to be performed by the agent over one or more time steps (step 808). As an example, the system can process the action selection network output to select a particular action to be performed by the agent for the current time step. When the system identifies and generates a set of optimization actions, the system can determine, e.g., by processing the action selection network output and the results of the numerical optimization of the objective functions for the optimization actions, whether to select an action for the current time step using the action selection network output or to select one of the optimization actions.

As the agent performs the actions, the system can update the reference agent trajectory. As an example, the reference agent trajectory can characterize the actions performed by the reference agent at each time step and the system can update the trajectory by adding the selected actions to the trajectory. As a further example, the reference agent trajectory can characterize observations received at each time step and the system can update the trajectory by adding the received observations to the trajectory.

At each time step, the system can determine whether the trajectory has been completed (step 810). As an example, the system may determine that the trajectory is complete after a predetermined number of time steps. As another example, the system may determine that the trajectory is complete when the agent completes a task. If the system determines that the trajectory is not complete, the system can continue to generate the trajectory by selecting actions for subsequent time steps.

When the system determines that the trajectory is complete, the system can return the generated reference agent trajectory (step 812).

FIG. 9 is a flow diagram of an example process for clustering reference trajectories. For convenience, the process 900 will be described as being performed by a system of one or more computers located in one or more locations. For example, an agent guidance system, e.g., the agent guidance system 100 of FIG. 1, appropriately programmed in accordance with this specification, can perform the process 900.

The system obtains a collection of reference trajectories generated by one or more reference agents (step 902). As described above, the system can obtain the collection of reference trajectories by any of a variety of methods. As an example, the system can access and retrieve stored reference trajectories as part of obtaining the collection of reference trajectories. As another example, the system can obtain reference trajectories by monitoring reference agents interacting with the environment. As another example, the system can obtain reference trajectories by controlling reference agents trained to interact with the environment.

For each of the collection of reference trajectories, the system can determine an array of features representing the reference trajectory. The array of features representing a reference trajectory can include numerical values characterizing, e.g., an agent for the reference trajectory, an environment for the reference trajectory, states of the agent for the reference trajectory over a time interval of the reference trajectory, states of the environment for the reference trajectory over the time interval of the reference trajectory, a performance score (e.g., for a particular task) for the reference trajectory, actions performed by the agent during the reference trajectory, a length of the reference trajectory, a received reward for the reference trajectory, and so on.

The system clusters the collection of reference trajectories to generate a collection of trajectory clusters (step 904). In general, the reference trajectories included within each generated trajectory cluster are similar with one another, as determined by a measure of similarity. In particular, when the system determines an array of features for each reference trajectory, the system can cluster the reference trajectories based on the numerical values for the arrays of features for the reference trajectories by, e.g., determining a distance metric between the reference trajectories based on differences between the numerical values for the arrays of features for the reference trajectories.

As an example, one of the trajectory clusters can include reference trajectories that result in a similar performance on the task, e.g., based on using similar actions, performing the task in a similar amount of time, attaining a similar reward, and so on. As another example, one of the trajectory clusters can include reference trajectories generated by similar agents. As another example, the trajectory clusters can include reference trajectories from similar variants of the environment.

The system can cluster the collection of reference trajectories using any of a variety of clustering methods, e.g., expectation-maximization clustering, k-means clustering, agglomerative clustering, Gaussian Mixture Model clustering, spectral clustering, etc.

FIG. 10 is a flow diagram of an example process for training (e.g., fine-tuning) a generative model to produce guidance data for a target agent based on a received prompt. For convenience, the process 1000 will be described as being performed by a system of one or more computers located in one or more locations. For example, an agent guidance system, e.g., the agent guidance system 100 of FIG. 1, appropriately programmed in accordance with this specification, can perform the process 1000.

In general, the generative model can be any of a variety of machine learning models for conditional data generation. More particularly, the generative model can be a machine learning model with a set of model parameters, e.g., a neural network, configured to appropriately generate the guidance data based on the received prompts. The generative model can have any appropriate architecture for processing the prompts to generate the guidance data. For example, the generative model can include attention layers (e.g., self-attention layers, cross-attention layers, etc.). In some implementations, the generative model can be an auto-regressive model configured to process the prompt to auto-regressively generate a sequence of tokens representing the guidance data. In some implementations, the generative model can process a sequence of tokens representing the prompt. For example, the generative model can have a Transformer architecture as described by Vaswani et al. in “Attention is All You Need”, a Perceiver architecture as described by Jaegle et al. in “Perceiver: General Perception with Iterative Attention”, a Visual Language Model architecture as described by Radford et al. in “Learning Transferable Visual Models from Natural Language Supervision”, and so on.

When the guidance data includes sequences of text, the generative model can, at least in part, determine a distribution over a space of possible sequences of text based on a received prompt and generate sequences of text by generating samples from the determined distribution. For example, when the generative model is configured to generate a sequence of tokens representing the guidance data, the sequence of tokens representing the guidance data can include tokens representing respective sequences of text.

A process for training the generative model to perform a language processing task using a corpus of textual training data is described below.

The system can train (e.g., pre-train) the generative model on a corpus of general textual data that is not specific to the environment being interacted with by the target agent (step 1002). As an example, the system can train the generative model to perform a language processing task, e.g., next token prediction, on a general text corpus, e.g., a generic text dataset. Example methods for pre-training the generative model are described by Vaswani et al. in “Attention is All You Need”, Jaegle et al. in “Perceiver: General Perception with Iterative Attention”, and Radford et al. in “Learning Transferable Visual Models From Natural Language Supervision”.

The system can then fine-tune the generative model (e.g., to perform a language modeling task, e.g., a next token prediction task) on a corpus of environment-specific textual data that is specific to the environment being interacted with by the target agent (step 1004). For example, the corpus of environment-specific textual data can include textual data describing a collection of reference trajectories. As another example, the corpus of environment-specific textual data can include textual data describing a collection of trajectory clusters. As another example, comprises textual data characterizing one or more tasks to be performed by the target agent in the environment. As a further example, the corpus of environment-specific textual data can include example prompts including example descriptions of feature descriptor differences (e.g., example descriptions as generated by the system following step 710 of FIG. 7 for example agent trajectories) and the system can fine-tune the generative model to generate, e.g., target guidance data for the example prompts.

FIG. 11 is a flow diagram of an example process for generating guidance data based on a prompt. For convenience, the process 1100 will be described as being performed by a system of one or more computers located in one or more locations. For example, an agent guidance system, e.g., the agent guidance system 100 of FIG. 1, appropriately programmed in accordance with this specification, can perform the process 1100.

The system receives a prompt for generating guidance data for an agent (step 1102). As described above, the prompt can characterize the relation between a base trajectory cluster and one or more guidance trajectory clusters. In some implementations, the prompt can characterize the differences between certain feature descriptors of the base and guidance trajectory clusters, e.g., by including text sequences describing the differences between the feature descriptors.

In some implementations, the prompt can characterize the relation between the base trajectory cluster and target agent trajectories for the agent. For example, the prompt can characterize the differences between certain feature descriptors of the base trajectory clusters and the target agent trajectories, e.g., by including text sequences describing the differences between the feature descriptors.

The system then generates guidance data for the agent as conditioned on the prompt (step 1104). As described above with respect to FIG. 10, the system can generate the guidance data for the agent using a generative model. The generative model can be an auto-regressive model configured to process the prompt to generate the guidance data. For example, the generative model can auto-regressively generate each of a sequence of tokens representing the guidance data by processing (i) a sequence of tokens representing the prompt and (ii) each of the sequence of tokens representing the guidance data previously generated by the generative model. As part of generating each output token for the sequence of tokens representing the guidance data, the generative model can determine a score distribution over a set of possible tokens and select the output token from the set of possible tokens based on the determined score distribution.

As described above, the guidance data can characterize a variety of forms of assistance for the agent. For example, the guidance data can characterize recommended next actions to be performed by the target agent. As another example, guidance data can characterize a recommended strategy for accomplishing a task in the environment.

In some implementations, the system can generate a sequence of text based on the prompt and provide the generated sequence of text as part of the guidance data (step 1106). For example, the generative model can be a text generation neural network and the sequence of tokens representing the guidance data can include text tokens representing text for the guidance data.

In some implementations, the system can generate audio based on the prompt and provide the generated audio as part of the guidance data (step 1108). For example, the system can generate a vocalization of the text description of the guidance data based on the prompt and provide the audio for playback on a user speaker. For example, the generative model can be an audio generation neural network and the sequence of tokens representing the guidance data can include audio tokens representing vocalized audio for the guidance data.

In some implementations, the system can generate video based on the prompt and provide the generated video as part of the guidance data (step 1110). For example, the system can generate a video of an avatar speaking audio lines generated for the guidance data based on the prompt and provide the video for playback on a user display. For example, the generative model can be a video generation neural network and the sequence of tokens representing the guidance data can include video tokens representing video data for the guidance data.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining a collection of reference trajectories representing interactions of each of a plurality of reference agents with an environment;
clustering the collection of reference trajectories to generate a set of trajectory clusters that each comprise a plurality of reference trajectories;
receiving a request to generate guidance data to be provided to a target agent interacting with an environment; and
in response to the request, generating the guidance data using a generative neural network and the set of trajectory clusters, comprising:
generating a prompt to be provided to the generative neural network, comprising:
determining a respective similarity measure between: (i) one or more target trajectories representing interactions of the target agent with the environment, and (ii) each trajectory cluster in the set of trajectory clusters;
selecting a base trajectory cluster based at least in part on the similarity measures between the target trajectories and each trajectory cluster in the set of trajectory clusters; and
generating the prompt to be provided to the generative neural network based at least in part on feature descriptors of the base trajectory cluster;
generating the guidance data for the target agent using the generative neural network, in accordance with trained values of a set of neural network parameters of the generative neural network, while the generative neural network is conditioned on the prompt, wherein the set of neural network parameters of the generative neural network have been trained by a machine learning training technique; and
providing the guidance data to the target agent.

2. (canceled)

3. (canceled)

4. The method of claim 1, wherein selecting the base trajectory cluster based at least in part on the similarity measures comprises:
selecting the base trajectory cluster as a trajectory cluster that, among the set of trajectory clusters, is most similar to the one or more target trajectories according to the respective similarity measures for the set of trajectory clusters.

5. The method of claim 1, wherein generating the prompt based at least in part on feature descriptors of the base trajectory cluster comprises:
selecting a guidance trajectory cluster from among the set of trajectory clusters; and
generating the prompt based at least in part on data characterizing differences between: (i) reference trajectories included in the base trajectory cluster, and (ii) reference trajectories included in the guidance trajectory cluster.

6. The method of claim 5, wherein each trajectory cluster in the set of trajectory clusters is associated with a respective performance score based on a respective return associated with each reference trajectory included in the cluster; and
wherein the return associated with a reference trajectory characterizes a cumulative measure of rewards received during the interaction characterized by the reference trajectory.

7. The method of claim 6, wherein identifying the guidance trajectory cluster from among the set of trajectory clusters comprises:
selecting the guidance trajectory cluster based at least in part on the guidance trajectory cluster having a higher performance score than the base trajectory cluster.

8. The method of claim 5, wherein the data characterizing differences between: (i) reference trajectories included in the base trajectory cluster, and (ii) reference trajectories included in the guidance trajectory cluster, has been generated by performing operations comprising:
determining, for each feature descriptor in a set of feature descriptors, a difference between: (i) a base value of the feature descriptor based on reference trajectories included in the base trajectory cluster, and (ii) a guidance value of the feature descriptor based on reference trajectories included in the guidance trajectory cluster.

9. The method of claim 8, wherein generating the prompt comprises, for each of one or more feature descriptors in the set of feature descriptors:
generating a sequence of text that characterizes the difference between: (i) the base value of the feature descriptor based on reference trajectories included in the base trajectory cluster, and (ii) the guidance value of the feature descriptor based on reference trajectories included in the guidance trajectory cluster; and
including the generated sequence of text in the prompt.

10. The method of claim 8, wherein generating the prompt based at least in part on data characterizing differences between: (i) reference trajectories included in the base trajectory cluster, and (ii) reference trajectories included in the guidance trajectory cluster comprises:
accessing precomputed data that, for each pair of trajectory clusters comprising a first trajectory cluster and a second trajectory cluster from the set of trajectory clusters, characterizes differences between: (i) reference trajectories included in the first trajectory cluster, and (ii) reference trajectories included in the second trajectory cluster.

11. (canceled)

12. The method of claim 1, further comprising:
assigning the one or more target trajectories representing interactions of the target agent with the environment to respective trajectory clusters in the set of trajectory clusters.

13. The method of claim 1, wherein the generative model has been trained on a corpus of textual data to perform the language modeling task.

14. The method of claim 13, wherein training the generative model on the corpus of textual data to perform the language modeling task comprises:
training the generative model on a corpus of general textual data that is not specific to the environment being interacted with by the target agent; and
fine-tuning the generative model on a corpus of environment-specific textual data that is specific to the environment being interacted with by the target agent.

15. The method of claim 1, wherein the guidance data comprises a sequence of text.

16. The method of claim 15, wherein providing the guidance data to the agent comprises:
providing the sequence of text for presentation on a display of a user interface.

17. The method of claim 16, wherein providing the guidance data to the agent comprises:
generating audio data that defines a vocalization of the sequence of text; and
causing the vocalization of the sequence of text to be played from a speaker.

18. The method of claim 17, further comprising:
generating video data that depicts an avatar mouthing the sequence of text; and
providing the video data for presentation on a display while the vocalization of the sequence of text is played from the speaker.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining a collection of reference trajectories representing interactions of each of a plurality of reference agents with an environment;
clustering the collection of reference trajectories to generate a set of trajectory clusters that each comprise a plurality of reference trajectories;
receiving a request to generate guidance data to be provided to a target agent interacting with an environment; and
in response to the request, generating the guidance data using a generative neural network and the set of trajectory clusters, comprising:
generating a prompt to be provided to the generative neural network, comprising:
determining a respective similarity measure between: (i) one or more target trajectories representing interactions of the target agent with the environment, and (ii) each trajectory cluster in the set of trajectory clusters;
selecting a base trajectory cluster based at least in part on the similarity measures between the target trajectories and each trajectory cluster in the set of trajectory clusters; and
generating the prompt to be provided to the generative neural network based at least in part on feature descriptors of the base trajectory cluster;
generating the guidance data for the target agent using the generative neural network, in accordance with trained values of a set of neural network parameters of the generative neural network, while the generative neural network is conditioned on the prompt, wherein the set of neural network parameters of the generative neural network have been trained by a machine learning training technique; and
providing the guidance data to the target agent.

20. One or more non-transitory computer storage media storing instructions that when executed by one or more computers cause the one or more computers to perform operations comprising:
obtaining a collection of reference trajectories representing interactions of each of a plurality of reference agents with an environment;
clustering the collection of reference trajectories to generate a set of trajectory clusters that each comprise a plurality of reference trajectories;
receiving a request to generate guidance data to be provided to a target agent interacting with an environment; and
in response to the request, generating the guidance data using a generative neural network and the set of trajectory clusters, comprising:
generating a prompt to be provided to the generative neural network, comprising:
determining a respective similarity measure between: (i) one or more target trajectories representing interactions of the target agent with the environment, and (ii) each trajectory cluster in the set of trajectory clusters;
selecting a base trajectory cluster based at least in part on the similarity measures between the target trajectories and each trajectory cluster in the set of trajectory clusters; and
generating the prompt to be provided to the generative neural network based at least in part on feature descriptors of the base trajectory cluster;
generating the guidance data for the target agent using the generative neural network, in accordance with trained values of a set of neural network parameters of the generative neural network, while the generative neural network is conditioned on the prompt, wherein the set of neural network parameters of the generative neural network have been trained by a machine learning training technique; and
providing the guidance data to the target agent.

21. The non-transitory computer storage media of claim 20, wherein selecting the base trajectory cluster based at least in part on the similarity measures comprises:
selecting the base trajectory cluster as a trajectory cluster that, among the set of trajectory clusters, is most similar to the one or more target trajectories according to the respective similarity measures for the set of trajectory clusters.

22. The non-transitory computer storage media of claim 20, wherein generating the prompt based at least in part on feature descriptors of the base trajectory cluster comprises:
selecting a guidance trajectory cluster from among the set of trajectory clusters; and
generating the prompt based at least in part on data characterizing differences between: (i) reference trajectories included in the base trajectory cluster, and (ii) reference trajectories included in the guidance trajectory cluster.

23. The non-transitory computer storage media of claim 22, wherein each trajectory cluster in the set of trajectory clusters is associated with a respective performance score based on a respective return associated with each reference trajectory included in the cluster; and
wherein the return associated with a reference trajectory characterizes a cumulative measure of rewards received during the interaction characterized by the reference trajectory.
